(19) United States
(12) Patent Application Publication
(10) Pub. No.: US 2009/0285736 A1
(43) Pub. Date: Nov. 19, 2009

(54) Catalytic Soot Filter and Use Thereof in Treatment of Lean Exhaust Gases

(75) Inventors: Adolf SCHAFER-SINDLINGER, Frankfurt (DE); Marcus Pfeifer, Solingen (DE); Ulrich Hackbarth, Maxdorf (DE); Wilfried Muller, Karben (DE); Egbert Lox, Grebenhain-Hochwaldhausen (DE); Thomas Kreuzer, Karben (DE); Roger Staab, Freigericht (DE); Michael Hoffmann, Aschaffenburg (DE); Jurgen Gieshoff, Biebergemund (DE)

Correspondence Address: KALOW & SPRINGUT LLP, 488 MADISON AVENUE, 19TH FLOOR, NEW YORK, NY, 10022, US

(73) Assignee: UMICORE AG & CO.KG

(21) Appl. No.: 12/465,141

(22) Filed: May 13, 2009

Related U.S. Application Data
(63) Continuation of application No. 10/381,295, filed on Nov. 14, 2003.

(30) Foreign Application Priority Data
Sep. 29, 2000 (DE) 100 48 511.1
Apr. 18, 2001 (EP) 01 109 570.0

(51) Int. Cl. B01D 53/94; B01D 50/00

(52) U.S. Cl. 423/213.5; 422/169

(57) ABSTRACT

The invention provides a process for reducing the amounts of carbon monoxide, hydrocarbons and soot particles in the lean exhaust gas from an internal combustion engine using a particle filter, wherein the soot particles have a soot ignition temperature T_{Z} and the particle filter is regenerated from time to time by raising the temperature of the particle filter to above the soot ignition temperature and burning the soot particles, wherein the temperature of the filter is increased to the temperature required to initiate soot ignition by burning additional fuel on the catalytic coating when the exhaust gas back pressure reaches a predetermined value. The process is characterised in that the particle filter is provided with a catalytic coating comprising a first group of components for reducing the ignition temperature of soot, said first group of components contains at least one oxygen storage component and at least one platinum group metal selected from the group consisting of platinum, palladium and rhodium. In a preferred embodiment of the process the catalytic coating further comprises a second group of components for oxidising carbon monoxide and hydrocarbons, said second group of components comprises at least a support material selected from the group consisting of aluminium oxide, silicon oxide, titanium oxide, zirconium oxide and zeolite and at least one platinum group metal selected from the group consisting of platinum, palladium and rhodium deposited on said support materials.

This application is a continuation of U.S. patent application Ser. No. 10/381,295 filed Nov. 14, 2003, which claims the benefit of International Patent Application No. PCT/EP01/11057, with an international filing date of Sep. 25, 2001, which application claims the benefit of German Patent Application No. 100485111, filed Sep. 29, 2000, and claims benefit of European Patent Application No. 01109570.0, filed Apr. 18, 2001. The entire disclosures of these applications are hereby incorporated herein by reference.

### FIELD OF THE INVENTION

### Background of the Invention

The invention provides a process for removing carbon monoxide, hydrocarbons and soot particles from lean exhaust gases from an internal combustion engine by using a catalytically coated particle filter.

Particle filters are able to filter out soot particles from the lean exhaust gases from an internal combustion engine and thus prevent their emergence into the atmosphere. The use of various filter designs such as, for example, wall flow filters, filters made from ceramic fibres or expanded ceramic or metallic materials as well as filters made of wire mesh are used for this purpose. Degrees of filtration of well above 95% are produced with these.

The intrinsic difficulty however, is not filtration of the soot particles, but regeneration of the filter used. Carbon soot burns only at temperatures of about 600° C. However, these temperatures are generally reached by modern diesel engines, for example, only under full load. Therefore, additional, supporting measures are required to oxidise the soot particles separated from the exhaust gases.

Active and passive measures have to be differentiated: In the case of active measures, the temperature of the filter is increased to above the temperature required to oxidise the soot, for example by an electrical heating system. These types of measures are always associated with an increase in fuel consumption. In the case of passive systems, the ignition temperature for soot is lowered, for example by the use of organometallic fuel additives such as ferrocene or by a catalytic coating on the filter.

DE 31 41 713 A1 describes a coating which contains silver vanadate as the active substance for lowering the ignition temperature of soot. A further development of this invention is described in DE 32 32 729 C2. According to this, the ignition temperature-lowering coating may contain lithium oxide, vanadium pentoxide with an alkali metal oxide, a vanadate, a perrhenate or a combination of these substances as the active substance.

DE 34 07 172 describes a device for removing oxidisable solid, liquid and gaseous harmful substances from the exhaust gases from diesel engines. For this purpose, the DE 34 07 172 describes a device for removing oxidisable solid, liquid and gaseous harmful substances from the exhaust gases from diesel engines. For this purpose the device contains, in a housing, filter elements arranged directly adjacent to each other or at a distance from each other, wherein at least one filter element A which contains a catalyst for lowering the ignition temperature of the soot and for promoting its combustion and at least one filter element B which contains a catalyst for promoting the combustion of gaseous harmful substances alternate several times.

Koberstein et. al. describe a wall flow filter which contains a combined coating with an ignition catalyst on the channel walls on the gas inlet face and an oxidation catalyst on the gas outlet face, in “Einsatz von Abgasnachbehandlungseinrichtungen” (VDI-Report No. 559; VDI-Verlag 1985, 275-296). The function of the oxidation catalyst is to oxidise the hydrocarbons being released during filter regeneration and thus to render them harmless.

U.S. Pat. No. 4,510,265 describes a self-cleaning diesel particle filter. The filter is provided with a catalyst mixture of a metal from the platinum group and silver vanadate. The presence of the catalyst mixture reduces the ignition temperature of the diesel particles.

U.S. Pat. No. 4,849,399 also describes a catalyst composition for lowering the ignition temperature of diesel soot. The composition contains sulfur-resistant inorganic oxides from the group titanium oxide, zirconium oxide, silicon oxide, aluminium silicate and aluminium oxide and also catalytically active components from the group platinum, palladium and rhodium deposited on the oxide.

According to U.S. Pat. No. 5,100,632, the ignition temperature of diesel soot can also be reduced with a catalyst composition which contains a platinum group metal and an alkaline earth metal. A catalyst composition consisting of magnesium oxide and platinum and/or rhodium is suggested in particular.

U.S. Pat. No. 5,758,496 describes a particle and exhaust gas treatment system which contains a particle filter, the porous wall of which is coated directly with a catalytically active metal for oxidising carbon monoxide and unburnt hydrocarbons. To reduce the ignition temperature of the diesel soot deposited on the filter, an additive is added to the fuel. This additive consists of an organometallic compound in a liquid carrier medium. The organometallic compounds are in particular copper, nickel or cerium octoate.

U.S. Pat. No. 5,792,436 describes a process for removing nitrogen oxides and sulfur oxides from lean exhaust gases from internal combustion engines. Here, the exhaust gases are passed over a catalysed trap which contains a combination of a nitrogen oxide and sulfur oxide-absorbing material and an oxidation catalyst. The absorbing material can be regenerated by raising the temperature of the trap. For this purpose, combustible components, which are burnt on the oxidation catalyst and which increase the temperature of the trap to the desorption temperature for nitrogen oxides and sulfur oxides, are added to the exhaust gas stream during the regeneration phase. Suitable absorber materials are oxides, carbonates, hydroxides or mixed oxides of magnesium, calcium, strontium, barium and lanthanum and also oxides of cerium, praseodymium and oxides of elements with the atomic numbers 22 to 29. The oxidation catalyst consists of at least one platinum group metal. The absorbing material and oxidation catalyst are applied in the form of a coating on, for example, a honeycomb structure with channels which are parallel and can be freely flowed through or on spherical or tablet-shaped support structures which are arranged in a bed.

U.S. Pat. No. 6,023,928 describes a process for the simultaneous reduction in the amounts of soot particles, unburnt hydrocarbons and carbon monoxide present in the exhaust gas from a diesel engine. The process uses a particle filter catalysed with platinum in combination with a cerium-containing fuel additive in order to lower the ignition temperature of the soot.

Lowering the soot ignition temperature by the use of a soot ignition coating or a fuel additive does not generally also guarantee regeneration of the filter under low loads so currently a combination of active and passive measures are frequently used.

The combination of an oxidation catalyst in association with a particle filter has proven especially suitable. The oxidation catalyst is arranged upstream of the particle filter in the exhaust gas unit. As a result of post-injection or some other step taken in the engine, unburnt fuel and carbon monoxide gain access to the oxidation catalyst and are catalytically converted there to carbon dioxide and water. With the aid of the heat of reaction which becomes available, the exhaust gas and thus also the downstream particle filter, are heated. Such a system is described, for example, in GB 2 134 407 A. In association with a catalytic coating on the filter for lowering the ignition temperature of the soot or fuel additives, the amount of fuel post-injected is reduced and the filter can be regenerated at any operational stage of the engine.

EP 0 341 832 B1 follows a different route. It describes a process for treating the exhaust gas from heavy goods vehicles. The exhaust gas is first passed over an oxidation catalyst without filtration in order to oxidise the nitrogen monoxide present therein to nitrogen dioxide. The nitrogen dioxide-containing exhaust gas is then used to burn the particles deposited on a downstream filter, wherein the amount of nitrogen dioxide is sufficient to perform combustion of the particles deposited on the filter at a temperature of less than 400° C. Here, continuous regeneration of the particle filter should be possible without periodic post-injection of fuel being required in order to increase the exhaust gas temperature.

EP 0 835 684 A2 describes a process for treating exhaust gases from light goods vehicles and private cars. According to this process, the exhaust gas is passed over two catalysts arranged in sequence, the first of which oxidises the nitrogen monoxide present in the exhaust gas to nitrogen dioxide which then oxidises soot particles, which have been deposited on the second catalyst, to CO₂.

The processes described in the last two patents presuppose the presence of a high proportion of nitrogen oxides in the untreated exhaust gas from diesel engines. However, this is generally not the case to a sufficient extent.

In a press release dated 15 Apr. 1999, PSA Peugeot Citroën proposed a particle filter system for diesel engines with periodic regeneration of the particle filter by burning off the soot particles deposited on the filter. The soot particles deposited on the filter burn only at a temperature of 550° C. in the presence of oxygen. In order also to ensure regeneration of the particle filter during operational phases of the diesel engine with exhaust gas temperatures of only 150° C. (for example when driving in an urban environment), several measures are taken. On the one hand, the exhaust gas temperature is increased to 450° C. by active measures. On the other hand, a cerium-containing additive is added to the fuel, which lowers the natural combustion point of soot particles to 450° C. To increase the exhaust gas temperature to 450° C., fuel is injected into the cylinders during the expansion phase. This process is called post-injection in the following. As a result of the post-combustion associated with this, the exhaust gas temperature is increased by 200 to 250° C. In addition, further post-combustion of the unburnt hydrocarbons which result from post-injection takes place on an oxidation catalyst arranged upstream of the filter. That increases the exhaust gas temperature by a further 100° C.

The amount of fuel used for post-injection has to be controlled very precisely. If the amount of post-injected fuel is too large then the oxidation catalyst might be damaged due to thermal stress. Such damage may already occur at the envisaged exhaust gas temperatures between 450 and 550° C. since burning of the additional fuel at the catalytically active centres locally leads to much higher temperatures which may by far surpass the normal exhaust gas temperatures. Due to these high local temperatures neighboured noble metal crystallites which represent the catalytically active centres will sinter together to larger crystallites with a lower catalytically active surface area i.e. the noble metal dispersion becomes lower. As a consequence the light off temperature of the oxidation catalyst increases. The light off temperature is the temperature of the exhaust gas at which 50% of the pollutant in question is converted to harmless substances. The increase of the light off temperatures is especially detrimental for modern common rail diesel engines or direct injection diesel engines which due to their high efficiency have low exhaust gas temperatures.

Ageing of the oxidation catalyst due to improper post-injection may lead to a failure to comply with legal exhaust gas regulations with regard to the emission of carbon monoxide and hydrocarbons. Therefore, post-injection must be controlled very precisely.

The disadvantage of known processes and exhaust gas systems which add an additive to the fuel in order to lower the soot ignition temperature is the fact that the additive, after regeneration of the particle filter, accumulates in the form of an ash, for example cerium ash, in the filter. Added to this is an ash (oil ash) from combustion of the lubricating oil which is discharged with the exhaust gas. Cerium ash and oil ash form a powdery, flake-like composition which remains as a residue in the filter after combustion of the soot. After a certain time of operation of the internal combustion engine, depending on the size of the engine, several hundred grams of the ash accumulate in the filter and increase the exhaust gas back pressure. Therefore, this ash is usually removed from the filter by washing with water after a relatively long period of operation.

### SUMMARY OF THE INVENTION

Against the background of this prior art the object of the present invention is to provide a process which allows to reduce the amounts of carbon monoxide, hydrocarbons and soot particles in lean exhaust gases from internal combustion engines with a single catalysed particle filter. The process should also have a reduced energy consumption for regeneration of the particle filter and lengthen the interval between two washings of the filter for removing accumulated ashes. In addition, thermal damage due to post-injection should be minimised. A further object of the invention is a particle filter for use in the process according to the invention.

This object is achieved by a process for reducing the amounts of carbon monoxide, hydrocarbons and soot particles in the lean exhaust gas from an internal combustion engine using a particle filter, wherein the soot particles have a soot ignition temperature T_{Z} and the particle filter is regenerated from time to time by raising the temperature of the particle filter to above the soot ignition temperature and burning the soot particles, wherein the temperature of the filter is increased to the temperature required to initiate soot ignition by burning additional fuel on the catalytic coating when the exhaust gas back pressure reaches a predetermined value. The process is characterised in that the particle filter is provided with a catalytic coating comprising a first group of components for reducing the ignition temperature of soot, said first group of components contains at least one oxygen storage component and at least one platinum group metal selected from the group consisting of platinum, palladium and rhodium.

### BRIEF DESCRIPTION OF THE FIGURE

FIG. 1 shows a cross-section through a wall flow filter.

### DETAILED DESCRIPTION OF THE PREFERRED EMBODIMENTS

Further embodiments of the process are given in claims 2 to 14. The catalysed particle filter for use in the process is specified in claims 15 to 25.

In the context of this invention, a particle filter is understood to be a fine-pored, open-pored structure which is able to mechanically filter out from the exhaust gas stream 80, preferably more than 90% of the soot particles with a particle size in the range between 0.1 and 10 μm in the exhaust gas from a diesel engine. So-called deep-bed filters made of ceramic fibres or wire mesh are suitable for the process. Foamed ceramic or metallic materials may also be used, provided the required degree of filtration can be achieved. So-called wall flow filters are preferably used, with which degrees of filtration of greater than 95% can be obtained. Wall flow filters are constructed in the same way as the normal honeycomb structures used for car exhaust catalysts. The filter units have a generally cylindrical form and they contain flow channels for the exhaust gas which pass from an inlet end face to the outlet end face. Differently from normal exhaust gas catalysts, the channels of wall flow filters are alternately blocked at the end faces so that the exhaust gas is forced to flow through the porous channel walls on its route from the inlet end face to the outlet end face. The soot particles are filtered out of the exhaust gas stream in this way. Thus, wall flow filters have two sets of flow channels—inflow channels which are open at the inlet end face and blocked at the outlet end face and outflow channels which are blocked at the inlet end face and open at the outlet end face.

The process uses active and passive measures in order to reduce the particle content and the concentration of hydrocarbons and carbon monoxide in the exhaust gas from a diesel engine. The process is divided into a filtration phase and a regeneration phase, which are repeated in a cyclic manner. During the filtration phase, the soot particles are filtered out of the exhaust gas stream and deposited on the filter. At the same time most of the carbon monoxide and hydrocarbons are converted to carbon dioxide and water by the oxidative component in the catalytic coating. Due to the low concentration in the exhaust gas of these oxidisable exhaust gas components, the heat being released during reaction is not sufficient to heat the filter to the regeneration temperature. The exhaust gas back pressure in the filter increases with increasing deposition of soot and impairs the performance of the internal combustion engine. Therefore regeneration of the filter has to be initiated when a predetermined exhaust gas back pressure has been reached. For this, the hydrocarbon content in the exhaust gas is increased by supplying additional fuel. The additional fuel burns on the oxidative component in the catalytic coating and raises the temperature of the filter to the extent that the ignition temperature T_{Z} for soot is exceeded and the soot burns away. Then the supply of additional fuel is stopped and the filtration phase starts afresh.

Due to the first group of components in the catalytic coating in the particle filter which lowers the ignition temperature of the soot, less additional fuel is consumed for regeneration of the filter than without the presence of this component. Another advantage is direct combustion of the additional fuel on the filter. This saves the further fuel which would be required in the case of a separate oxidation catalyst installed upstream of the filter in order to heat the oxidation catalyst itself and the possibly long exhaust gas path between the oxidation catalyst and the particle filter to the regeneration temperature for the filter.

Another advantage of the invention as compared with the processes for reducing the soot ignition temperature by using fuel additives known from the prior art is the fact that no ashes from the additives can accumulate in the filter. Only the deposition of oil ash takes place, as also takes place in the other processes. The maintenance interval for removing such ashes from the filter by appropriate rinsing or washing procedures can therefore be substantially longer than in processes using fuel additives. As demonstrated in appropriate trials, the catalytic coating on the filter is resistant to such washing procedures.

To reduce the ignition temperature of soot, the first group of components of the catalytically active coating on the filter contains at least one oxygen storage component and, to oxidise carbon monoxide and hydrocarbons, the first group of components contains at least one of the platinum group metals selected from the group consisting of platinum, palladium and rhodium. The light off temperature of this first group of components for the oxidation of carbon monoxide and hydrocarbons typically lies above 150 to 200° C.

Preferably, the oxygen storage component contains at least one material selected from the group consisting of cerium oxide, cerium/zirconium mixed oxide, manganese oxide, iron oxide, copper oxide, zinc oxide lanthanum oxide bismuth oxide, niobium oxide and tantalum oxide or mixtures thereof. A cerium oxide stabilised with zirconium oxide which contains 10 to 30 wt. % of zirconium oxide, with respect to the total weight of stabilised material, is preferably used.

Thermally stabilised oxygen storage materials in accordance with DE 197 14 707 A1 are particularly suitable for the invention. These are oxygen storage materials with high thermal stability based on cerium oxide and which contain at least one stabiliser from the group consisting of praseodymium oxide, lanthanum oxide, yttrium oxide and neodymium oxide, wherein the stabiliser(s) and optionally cerium oxide are present in a highly disperse form on the specific surface area of a high surface area support material from the group consisting of aluminium oxide, zirconium oxide, titanium oxide, silicon dioxide, cerium oxide and mixed oxides thereof, in particular on the cerium/zirconium mixed oxide mentioned above.

It has been shown that multi-component coatings on the particle filter have a synergistic effect on lowering the soot ignition temperature. Whereas a coating of cerium oxide lowers the soot ignition temperature by only about 30 to 40° C. and hardly any reduction in the ignition temperature can be detected in the case of a coating of pure manganese oxide, a mixture of cerium oxide and manganese oxide lowers the ignition temperature by about 60 to 70° C. A mixture with the ratio by weight of 1:1 is preferably used.

However, mixtures with the ratios by weight of cerium oxide to manganese oxide of 1:5 to 5:1 may also be used. Further lowering of the ignition temperature is obtained by the admixture of a compound of an alkaline earth metal selected from the group consisting of magnesium, calcium, barium, strontium or mixtures thereof, in particular calcium oxide. Due to the use of a coating consisting of cerium oxide, manganese oxide and calcium oxide in the ratio by weight of 4:4:1, the ignition temperature of soot particles can be lowered by, for example 110° C.

In addition to the first group of components the catalytic coating may contain a second group of components for oxidising carbon monoxide and hydrocarbons with high efficiency. The light off temperature of this second group of materials for oxidising carbon monoxide and hydrocarbons typically lies below 150° C. and is thus considerably lower than the corresponding light off temperature of the first group of components. For that aim the second group of components comprises at least a support material selected from the group consisting of aluminium oxide, silicon oxide, titanium oxide, zirconium oxide and zeolite and at least one platinum group metal selected from the group consisting of platinum, palladium and rhodium deposited on said support materials. Most preferably active aluminium oxide or active aluminium oxide stabilised with 0.5 to 10 wt.-% of silicon oxide are used as support materials. For storing hydrocarbons during operating phases of the diesel engine with low exhaust gas temperatures zeolites catalysed with platinum, palladium and/or rhodium may be added to the second group of components.

Various types of filter are suitable for the process such as, for example, wall flow filters, filters made of ceramic fibres or foamed ceramic or metallic materials and also filters made of wire mesh. Suitable materials for such filters are silicon carbide, silicon nitride, cordierite or sodium zirconium phosphate. Preferably wall flow filters are used having inflow and outflow flow channels for the exhaust gases separated from each other by porous channel walls.

In a special embodiment of the process the particle filter is coated with both groups of components i.e. the first group of components reducing the ignition temperature of soot and the second group of components for oxidising carbon monoxide and hydrocarbons at relatively low temperatures are coated onto the channel walls of the inflow channels of a wall flow filter as a single layer. The techniques for applying such a catalytic coating to a carrier body such as a particle filter are abundantly described in the literature and are well known to the expert.

In a preferred embodiment of the process the catalytic coating comprises two layers one upon the other wherein the first layer is coated directly on the channel walls of the inflow channels of a wall flow filter and the first layer comprises the second group of components and the second layer lies on said first layer and comprises the first group of components.

In a further preferred embodiment of the process the catalytic coating comprises again two layers wherein the first layer is coated on or into the channel walls of the inflow channels of a wall flow filter and the first layer comprises the first group of components and the second layer is coated on the channel walls of the outflow channels and comprises the second group of components. In this case the first group of components may be supplied as soluble precursor compounds which are dissolved in water and then impregnated into the channel walls. In that case the channel walls or at least part of the channel walls form the first layer.

In any case it is preferred that the exhaust gas first impinges onto the layer comprising the soot ignition components and only afterwards contacts the layer comprising the oxidising components. This ensures that the soot is deposited onto the soot ignition components so that the ignition temperature of the soot is lowered effectively. During regeneration this layer is able to burn most of the carbon monoxide and hydrocarbons generated by post-injection due to the elevated exhaust gas temperatures during this operational phase. Thus, during regeneration only minor amounts of unburnt exhaust gas components come into contact with the layer comprising the oxidising components and thereby the risk of thermal damages to these components is reduced.

During normal operation, the exhaust gas temperatures are lower so that the residual amounts of carbon monoxide and hydrocarbons contained in the exhaust gas cannot be burned by the first group of components because they have a relatively high light off temperature for these oxidising reactions. Carbon monoxide and hydrocarbons therefore pass this layer nearly unaffected and come into contact with the second group of components which have a higher oxidising activity and are therefore able to burn these residual amounts of carbon monoxide and hydrocarbons.

The concentration of the first group of components preferably lies between 20 and 150 g/l of the particle filter and the concentration of the second group of components preferably lies between 40 and 150 g/l of the particle filter. The concentration of platinum group metals of the first and second group of components lies within the range between 0.5 to 10 g/l of filter structure.

In order to initiate regeneration of the particle filter, the additional fuel may be added to the exhaust gas stream upstream of the particle filter. Preferably, however, the additional fuel required to heat the particle filter is injected into the cylinders of the internal combustion engine during the expansion phase. Due to the post-combustion taking place in the cylinders, the exhaust gas temperature is then increased by about 150 to 200° C. The entire amount of post-injected fuel is not burnt during post-combustion, so a certain proportion of unburnt hydrocarbons gets into the exhaust gas and is burnt directly on the filter due to the oxidative components in the catalytic coating.

The catalytically coated filter is able to convert a large proportion of the hydrocarbons and carbon monoxide emitted by the internal combustion engine into carbon dioxide and water so that for most operational phases of the internal combustion engine, no other catalyst is needed for treating the exhaust gas. To further improve the reaction rates for carbon monoxide and for hydrocarbons, in a particularly advantageous version of the process, an oxidation catalyst may be installed upstream of the particle filter, in a position close to the engine, this being of such a size that it converts only a small proportion of the fuel during post-injection of fuel to regenerate the filter, so that most of the additional fuel reaches the filter and can be converted there. Important factors in the design of this oxidation catalyst are the volume and the concentration of catalytically active components. These two factors can be optimised in a simple manner by a person skilled in the art, in accordance with the striven for objective.

The process according to the invention is preferably used for the treatment of exhaust gases from vehicles with a diesel engine. In order to perform the process according to the invention the drive unit in such a vehicle contains a diesel engine and an exhaust gas treatment unit with a particle filter, wherein, to regenerate the particle filter, the exhaust gas temperature of the engine can be increased by post-injection of fuel into the cylinders of the diesel engine during the expansion phase. The particle filter in this drive unit is provided with the catalytic coating described above which contains both a component to lower the ignition temperature T_{Z} of soot and also a component to oxidise carbon monoxide and hydrocarbons. A particularly advantageous embodiment of this drive unit contains an oxidation catalyst in a position near to the engine, and upstream of the particle filter, which is of such a size that only a small proportion of the fuel is converted during post-injection of fuel. This oxidation catalyst is preferably inserted in the exhaust line of the diesel engine upstream or slightly downstream of the turbocharger. It reaches its operating temperature very rapidly due to its position close to the engine and thus can reduce the amount of some of the CO and HC emissions during a cold start. Due to its small volume, however, it can no longer convert hydrocarbons which are additionally added by post-injection during regeneration of the particle filter and which are not fully burnt, so that most of the post-injected fuel reaches the particle filter and is burnt there on contact with the oxidising function in the catalytic coating.

To prepare the catalytic coating for the filter, the oxygen storage materials described are processed to give a preferably aqueous suspension. The filters are then coated with this suspension on the face intended to be the inlet face for the exhaust gas by using known methods. The suspension is then dried and calcined. The platinum group metal(s) may be deposited on the oxygen storage materials prior to making up the coating suspension or may be added to the aqueous coating suspension in the form of soluble precursor compounds. Alternatively, the platinum group metals may be introduced into the coating only after producing the coating, by subsequent impregnation with a solution of the precursor compounds. Following the impregnation procedure, the filter structure has to be dried and calcined again.

The following examples and figures are used for further explanation of the invention.

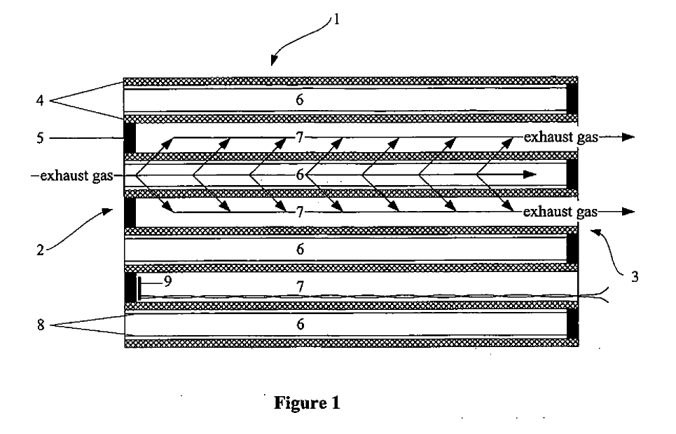

FIG. 1 shows a cross-section through a wall flow filter (1). The exhaust gas enters at the inlet end face (2) of the filter and emerges again at the outlet end face (3). Parallel flow channels (6) and (7) for the exhaust gas pass though the filter from the inlet end face to the outlet end face, these being bounded by porous channel walls (4). Alternate channels are sealed with stoppers (5). Channels (7) are sealed at the inlet end face and channels (6) are sealed at the outlet end face. The exhaust gas enters channels (6) and is forced to pass through the porous channel walls into the neighbouring channels (7). The filter is coated on the inlet face with the catalytic coating, that is to say the coating (8) is located on the channel walls of channels (6). The channel walls of channels (7) do not have any coating.

In the following examples, the filter inlet temperature is measured. For this purpose, a thermocouple (9) is inserted into a flow channel (7) from the gas outlet end of the filter, from the end right up to sealing stopper (5).

### Example 1

The reduction in soot ignition temperature by various catalytic coatings was tested. For the tests, cylindrical wall flow filters in accordance with FIG. 1 were used. These were made of silicon carbide and had a cell density (number of flow channels per cross-sectional area of the filter) of 31 cm⁻², a length of 15.2 cm and a diameter of 14.4 cm (volume about 2.5 l).

The coatings contained platinum as the oxidation-active component. The coating concentration each time was 50 g/l of filter structure and the platinum concentration each time was 5.3 g/l. Coatings of stabilised cerium oxide, calcium oxide, manganese oxide and of the oxide mixtures cerium oxide/manganese oxide (1:1) and cerium oxide/manganese oxide/calcium oxide (4:4:1) were tested. The oxidic materials were first coated with the amount of platinum required by impregnation with hexachloroplatinic acid, dried and calcined in air at 500° C. To coat the filter structure, the catalysed oxide powders were suspended in an amount of water which corresponded to the previously determined water absorption capacity of the filter structure. These suspensions were carefully milled and then poured over the inlet end faces of the filter structure. The filter structures were then dried and calcined.

The filter inlet temperature at the start of the soot burning process was determined for filters prepared in this way, instead of the soot ignition temperature. For this purpose, a thermocouple (9, FIG. 1) was pushed up to the sealing stopper from the end, in a flow channel sealed at the entrance side. In addition, the exhaust gas back pressure of the filter was monitored.

Each filter was first loaded with about 8 g of soot in a 2.2 l diesel engine (with direct injection) under defined operating conditions. Then regeneration of the filter was initiated by enriching the exhaust gas stream with hydrocarbons. Due to combustion of these hydrocarbons on the catalytic coating in the filter, the temperature of the filter increased. At the same time, the exhaust gas back pressure also increased due to the rising temperature. When a certain filter inlet temperature was reached the burning of soot was initiated, this being recognised by the exhaust gas back pressure passing through a maximum and then falling back to the value prior to coating the filter with soot. The filter inlet temperature at the time of passing through the maximum for the exhaust gas back pressure was recorded each time and is listed in table 1 below for various filter coatings.

TABLE 1
Filter inlet temperature when the soot starts to burn

| Coating | Filter inlet temperature |
|---|---|
| 50 g/l | [° C.] |
| Without coating | 585 |
| Pt/CeO₂ | 550 |
| Pt/MnO₂ | 580 |
| Pt/CaO | 545 |
| Pt/MnO₂/CeO₂ 1:1 | 520 |
| Pt/MnO₂/CeO₂/CaO 4:4:1 | 470 |

### Example 2

In addition, the conversion of carbon monoxide CO, hydrocarbons HC and nitrogen oxides NOx and also the degree of filtration of particles PM were determined for the 2.2 l diesel engine equipped with the filter coated with Pt/CeO₂ in a NEDC (New European Driving Cycle) test. The maximum exhaust gas temperature reached during the NEDC test was 450° C. During the test no regeneration of the filter was necessary.

The measurement results are given in table 2. The second line in table 2 gives the raw emissions from the engine. Line 3 gives the emissions after the particle filter and line 4 contains the degree of conversion calculated for these harmful substances.

TABLE 2

| | CO | HC | NOx | PM |
|---|---|---|---|---|
| | [g/km] | [g/km] | [g/km] | [g/km] |
| Crude emission | 2.033 | 0.291 | 0.493 | 0.118 |
| With particle filter | 0.3 | 0.072 | 0.463 | 0.005 |
| Conversion of harmful | 85 | 75 | 6 | 96 |
| substance [%] | | | | |

Using the catalyst particle filter according to the invention it is possible to reduce the amounts of both carbon monoxide, hydrocarbon and also soot particles to a considerable extent.

### Example 3

The filter from example 2 containing the Pt/CeO₂-coating was fitted to another 2.2 l diesel engine with direct injection. This engine exhibited a considerably cooler exhaust gas. The maximum temperature reached during the NEDC test was only 370° C. The results of the conversion and filtration measurements are listed in table 3. The second row in table 3 shows the raw emission of the engine. Line 3 gives the emissions after the particle filter and line 4 contains the degree of conversion calculated for these harmful substances.

TABLE 3

| | CO | HC | NOx | PM |
|---|---|---|---|---|
| | [g/km] | [g/km] | [g/km] | [g/km] |
| Crude emission | 1.440 | 0.160 | 0.362 | 0.051 |
| With particle filter | 0.674 | 0.072 | 0.413 | 0.003 |
| Conversion of harmful | 53 | 55 | — | 94 |
| substance [%] | | | | |

These measurements demonstrate that the first group of components for reducing the ignition temperature of soot is not very effective for oxidising carbon monoxide and hydrocarbons at the lower exhaust gas temperatures of this engine.

### Example 4

The outflow channels of a filter similar to that of example 3 were further coated with a layer comprising the second group of components for effectively oxidising carbon monoxide and hydrocarbons. This layer contained active aluminium oxide stabilised with silicon oxide, zeolite and platinum and was prepared according to example 1 in DE 197 53 738 A1. The concentration of this layer was 90 g/l. The total platinum group metal concentration of the catalytic coating was adjusted in such a way that the concentration was identical to the concentration in the preceding examples (5.3 g/l).

The same engine as in example 3 was used to determine the conversion of carbon monoxide, hydrocarbons, nitrogen oxides and particulates. The results are given in table 4.

TABLE 4

| | CO | HC | NOx | PM |
|---|---|---|---|---|
| | [g/km] | [g/km] | [g/km] | [g/km] |
| Crude emission | 1.440 | 0.160 | 0.362 | 0.051 |
| With particle filter | 0.123 | 0.021 | 0.398 | 0.005 |
| Conversion of harmful | 91 | 87 | — | 90 |
| substance [%] | | | | |

Table 4 shows that the filter being catalysed with both groups of components is able to reduce carbon monoxide, hydrocarbons and particulates with high efficiency in the exhaust gas of the diesel engine with a maximum exhaust gas temperature during operation of 370° C. only.

1. A process for reducing the amounts of carbon monoxide, hydrocarbons and soot particles in the lean exhaust gas from an internal combustion engine using a particle filter, wherein the soot particles have a soot ignition temperature T_{Z} and the particle filter is regenerated from time to time by raising the temperature of the particle filter to above the soot ignition temperature and burning the soot particles, wherein the temperature of the filter is increased to the temperature required to initiate soot ignition by burning additional fuel on the catalytic coating when the exhaust gas back pressure reaches a predetermined value, characterised in that the particle filter is provided with a catalytic coating comprising a first group of components for reducing the ignition temperature of soot, said first group of components contains at least one oxygen storage component and at least one platinum group metal selected from the group consisting of platinum, palladium and rhodium.

2. A process according to claim 1, characterised in that the at least one oxygen storage component is selected from the group consisting of cerium oxide, cerium/zirconium mixed oxide, manganese oxide, iron oxide, copper oxide, zinc oxide, lanthanum. oxide, bismuth oxide, niobium oxide and tantalum oxide.

3. A process according to claim 2, characterised in that the first group of components further comprises a compound of an alkaline earth metal selected from the group consisting of magnesium, calcium, barium, strontium or mixtures thereof.

4. A process according to claim 3, characterised in that, the first group of components comprises platinum, cerium oxide, manganese 30 oxide and calcium oxide.

5. A process according to claim 4, characterised in that, the catalytic coating further comprises a second group of components for oxidising carbon monoxide and hydrocarbons, said second group of components comprises at least a support material selected from the group consisting of aluminium oxide, silicon oxide, titanium oxide, zirconium oxide and zeolite and at least one platinum group metal selected from the group consisting of platinum, palladium and rhodium deposited on said support materials.

6. A process according to claim 5, characterised in that, the particle filter comprises a wall flow filter (1) having inflow (2) and outflow (3) flow channels for the exhaust gases separated from each other by porous channel walls (5).

7. A process according to claim 6, characterised in that, the catalytic coating comprises two layers one upon the other wherein the first layer is coated directly on or into the channel walls of the inflow channels of the particle filter and comprises the second group of components and the second layer lies on said first layer and comprises the first group of components.

8. A process according to claim 7, characterised in that, the catalytic coating comprises two layers wherein the first layer is coated on or into the channel walls of the inflow channels and comprises the first group of components and the second layer is coated on the channel walls of the outflow channels and comprises the second group of components.

9. A process according to claim 5, characterised in that, the concentration of the first group of components lies between 20 and 150 g/I of the particle filter and the concentration of the second group of components lies between 40 and 150 g/l of the particle filter.

10. A process according to claim 9, characterised in that, the concentration of the platinum group metals of the first and second group of components lies within the range between 0.5 and 10 g/l of particle filter.

11. A process according to claim 1, characterised in that, the material of the particle filter is selected from the group consisting of silicon carbide, silicon nitride, cordierite or sodium zirconium phosphate.

12. A process according to claim 1, characterised in that the additional fuel required to heat the particle filter is added to the exhaust gas stream upstream of the particle filter.

13. A process according to claim 1, characterised in that the additional fuel required to heat the particle filter is injected into the cylinders of the internal combustion engine during the expansion phase.

14. A process according to claim 13, characterised in that an oxidation catalyst is located upstream of the particle filter, in a position close to the engine, this being of such a size that it converts only a small proportion of the additional fuel injected.

15. A particle filter for use in the process of claim 1 selected from the group consisting of a wall flow filter, a wire mesh filter and an open pore ceramic or metallic foam filter, characterised in that the particle filter is provided with a catalytic coating comprising a first group of components for reducing the ignition temperature of soot, said first group of components contains at least one oxygen storage component and at least one platinum group metal selected from the group consisting of platinum, palladium and rhodium.

16. The particle filter according to claim 15, characterised in that the at least one oxygen storage component is selected from the group consisting of cerium oxide, cerium/zirconium mixed oxide, manganese oxide, iron oxide, copper oxide, zinc oxide, lanthanum oxide, bismuth oxide, niobium oxide and tantalum oxide.

17. The particle filter according to claim 16, characterised in that the first group of components further comprises a compound of an alkaline earth metal selected from the group consisting of magnesium, calcium, barium, strontium or mixtures thereof.

18. The particle filter according to claim 17, characterised in that, the first group of components comprises platinum, cerium oxide, manganese oxide and calcium oxide.

19. The particle filter according to claim 18, characterised in that, the catalytic coating further comprises a second group of components for oxidising carbon monoxide and hydrocarbons, said second group of components comprises at least a support material selected from the group consisting of aluminium oxide, silicon oxide, titanium oxide, zirconium oxide and zeolite and at least one platinum group metal selected from the group consisting of platinum, palladium and rhodium deposited on said support materials.

20. The particle filter of claim 19, characterised in that, the particle filter comprises a wall flow filter (1) having inflow (2) and outflow (3) flow channels for the exhaust gases separated from each other by porous channel walls (5).

21. The particle filter of claim 20, characterised in that, the catalytic coating comprises two layers one upon the other wherein the first layer lies directly on the channel walls of the inflow channels of the particle filter and comprises the second group of components and the second layer lies on said first layer and comprises the first group of components.

22. The particle filter of claim 20, characterised in that, the catalytic coating comprises two layers wherein the first layer is coated on the channel walls of the inflow channels and comprises the first group of components and the second layer is coated on the channel walls of the outflow channels and comprises the second group of components.

23. The particle filter of claim 19, characterised in that, the concentration of the first group of components lies between 20 and 150 g/l of the particle filter and the concentration of the second group of components lies between 40 and 150 g/l of the particle filter.

24. The particle filter of claim 23, characterised in that, the concentration of the platinum group metals of the first and second group of components lies within the range between 0.5 and 10 g/l of particle filter.

25. The particle filter of claim 15, characterised in that, the material of the particle filter is selected from the group consisting of silicon carbide, cordierite or sodium zirconium phosphate.
